(19) United States
(12) Patent Application Publication
(10) Pub. No.: US 2004/0218705 A1
(43) Pub. Date: Nov. 4, 2004

(54) Phase rotator, phase rotation method and clock and data recovery receiver incorporating said phase rotator

(75) Inventors: Hayden Clavie Cranford JR., Cary, NC (US); Matthew Richard Cordrey-Gal, Southampton (GB); James Stephen Mason, Eastleigh (GB); Philip John Murfet, Stockbridge (GB); Gareth John Nicholls, Brockenhurst (GB); Todd Morgan Rasmus, Cary, NC (US); Martin Leo Schmatz, Rueschlikon (SE); Peter Robert Seidel, Morrisville, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/769,437

(22) Filed: Jan. 30, 2004

Related U.S. Application Data
(60) Provisional application No. 60/443,732, filed on Jan. 30, 2003.

(51) Int. Cl. H04L 7/00

(52) U.S. Cl. 375/355; 375/371

(57) ABSTRACT

A Clock and Data Recovery (CDR) system includes a phase rotator which shifts the phases of signals received from a phase lock loop (PLL) to generate signals for oversampling a serial data stream. The signals derived from oversampling are processed to capture data and generate control signals for adjusting the phase rotator.

The present application claims priority of the Provisional Application Ser. No. 60/443,732 filed Jan. 30, 2003.

### FIELD OF THE INVENTION

The present invention generally relates to a phase rotator for use in the field of clock and data recovery (CDR) systems, and more particularly to the use of a differential phase rotator to enable a single PLL to supply clocks to multiple data links running asynchronously. Such a phase rotator is useful, for example, in digital data communications based on high-speed wire link technology for high-speed digital switches involving CDR.

### BACKGROUND OF THE INVENTION

When performing CDR, conventional systems track possible phase variations in an incoming data stream in order to ensure that all the information-carrying level transitions can be followed synchronously. To this end, the incoming data signal stream is processed by a CDR receiver which is capable of phase agility.

Now the speed of switches, especially in the context of internet switches, is currently developing fast. With this growth in speed, a problem now resides at the level of link technology, which is becoming the limiting factor for feeding data into and out of a digital core. Indeed, a digital core can comprise up to one hundred or more data links on one single digital chip.

In addition, such a chip performs digital functions which consume tens of Watts at few volts of power supply voltage, which means that tens of amps flow into and out of the chip at a few nanoseconds of cycle time. This creates a very noisy environment in terms of power supply swing, substrate noise, etc.

Under these conditions, there is a need for circuit structures that can perform CDR on the incoming data stream with a satisfactory bit error rate while being able to handle very high frequencies, e.g. up to 2.5 GHertz or more.

CDR circuit structures known in the art can be divided into two main categories: conventional analog-based phase-locked loop (PLL) feedback CDR receivers and digital oversampling receivers.

The following description relates to a typical analog PLL feedback CDR receiver circuit. The circuit has an input terminal which receives a data input signal that may be transmitted in differential form. The input is divided into first and second branches respectively for effecting a clock recovery and a data recovery.

The first branch forms an input to a PLL circuit. The latter classically comprises a phase comparator having two phase comparison inputs, a low-pass filter and an analog voltage controlled oscillator (VCO). The phase detector receives the input data signal and a quadrature output from the VCO at its respective phase comparison inputs, and outputs a voltage control signal to the VCO via the low pass filter. In this way, the VCO is forced to track the frequency of the incoming data input signal by maintaining a zero phase difference between the phase comparison inputs. The low pass filter ensures that the feedback loop containing the VCO is kept within the frequency response of the latter. In an example, the clock recovery signal is taken out from an in-phase output of the VCO for optimally sampling the data.

The above in-phase signal from the VCO also serves as a sampling clock signal for a data sampling circuit, the data input of which receives the data input signal from the second branch. The data sampling circuit thereby produces at an output terminal the data output signal corresponding to the data input signal sampled at the instantaneous recovered clock frequency.

Thus, the output phase of the VCO is controlled to match the optimum sampling point position by means of the PLL feedback control loop. Feedback control loops in general have a bandwidth limitation in the region of one tenth of the feedback frequency due to stability problems.

The above approach is the most commonly used owing to its simple structure. It served well in the past in applications which did not require very high frequencies and used only one channel, without relying on digital oversampling techniques.

The further description relates to a digital oversampling feed forward receiver with “a posteriori” decision. In this circuit, the incoming data stream is oversampled (i.e., sampled more than once per period of the input signal) to determine the data transition positions, also known as the edges of the data. The edge information serves as a basis for selecting, or “phase picking”, the best sample as data value in an “a posteriori” step.

The circuit comprises a PLL unit which delivers a number of clock output phases each having a common frequency corresponding to that of a reference signal, but at different phases relative to each other. The PLL unit is classically constructed from a multi-phase output VCO connected to a PLL feedback loop which receives the reference frequency signal. The latter is made to correspond as closely as possible to the frequency of the incoming data stream. The PLL feedback loop generally includes a phase comparator for comparing an output phase of the VCO with the phase of the reference frequency, the comparison output being fed back to the control input of the VCO via a low-pass filter.

The different phases from the VCO are supplied as clock signals to respective ones of a set of oversampling latches. The oversampling latches each receive the signal from the incoming data stream. Thus, for each period of the incoming data, the latches sample different points of the signal waveform.

The thus-sampled signals are supplied to what is known as a phase picking engine, whose function is to determine the position of the edge transitions in the incoming data on the basis of these sampled values.

The phase picking engine comprises a digital noise matched low-pass filter forming an input stage for the sampled values.

After the filter stage, the sampled values are supplied to respective data inputs of a digital edge detector and to a multiplexer which delivers the recovered data at a data output terminal. The digital edge detector effectively identifies the later one of two chronologically successive samples that marks a transition in the incoming data signal, and commands the multiplexer to designate that sample point as the basis for establishing the recovered data output. This sample (referred to as the best sample) is thus selected as the data value for a particular signal period in an ‘a posteriori’ step.

The above circuit implements a feed forward method with no inherent bandwidth limitation and potential non-causal data processing. Digital circuits after the sampling stage (e.g. a bit shifter and byte FIFOS) can take care of wrap-around effects occurring when there is a slight offset in the input data rate and the reference frequency.

Both of the above types of CDR receivers have their advantages and disadvantages.

The first approach described above is based on an analog control of the clock frequency and has an inherently limited jitter tracking bandwidth, but unlimited frequency tracking capability.

The second approach described above is purely digital and makes it possible to track jitter frequencies up to the bit rate, but only with limited jitter amplitude.

### SUMMARY OF THE INVENTION

The clock and data recovery system of the present invention includes a phase rotating system which provides phase shift signals used to identify the best sampling points for data and clock recovery from an incoming serial data stream. The incoming data stream is over-sampled to determine the data transition positions, also known as edges of the data. The edge information serves as a basis for moving the phases to the optimal time for phase sampling. A phase lock loop (PLL) containing a multi-phase output VCO produces the signals which are shifted by the phase rotating system. The phase shift signals are provided to and are used by a digitizing block to sample different points of the incoming data stream. The sampled signals are provided to a correlation block and in turn to a phase control logic for further processing. The correlation block provides error feedback signal, used by the phase control logic, and data output signal if certain expected sample patterns are not violated.

### BRIEF DESCRIPTION OF DRAWINGS

FIG. 1 shows a block diagram of a clock and data recovery (CDR) system according to teachings of the present invention.

FIG. 2 shows a block diagram for a set of phase rotators wherein each one is placed in each channel of a three-channel device and generates two output phase signals.

FIG. 3 shows a block diagram of weighted current sources according to teachings of the present invention.

FIG. 4 shows circuit diagram for each of the weighted current source in FIG. 3.

FIG. 5 shows the resultant rotated waveform produced after currents associated with each clock phase are summed.

FIG. 6 shows a circuit diagram for rotator core shown in FIG. 2.

### DETAILED DESCRIPTION OF AN EMBODIMENT

Embodiments of the present invention provide circuitry by way of a phase rotator which can serve for instance to implement a new type of receiver which offers advantages of both analog PLL-based CDRs and oversampling-based digital CDRs.

This is achieved by a phase rotator device for controllably effecting a phase shift on an oscillating signal (that may be of square waveform), comprising input means having a plurality of input channels for receiving a plurality of phases of the oscillating signal and output means having at least one output channel for delivering at least one phase of the oscillating signal with a controlled phase shift.

For each output channel there are weighting means for weighting the value of the oscillating signal at each input channel by a respective weighting coefficient and summing means for summing the weighted signal values at each input channel and delivering the summed value as a controllably shifted output phase at the output channel, and weighting coefficient supply means responsive to a phase shift control signal for controllably supplying evolving weighting coefficients to the weighting means thereby to create a phase shift at the output channel.

Preferred embodiments of the present invention provide a programmable current circuit that uses programmable weighting factors to generate programmable currents which are used to weight the PLL phase contributions which provide the differential phase rotated clock signal outputs.

The phase rotator of the preferred embodiments of the present invention is capable of producing a controlled phase shift e.g. on a multiphase input clock signal, and the data recovery receiver incorporating such a phase rotator in a feedback control loop can synchronously track level transitions in a high-speed data stream.

The receiver structure then performs clock and data recovery (CDR) on the incoming serial data stream. The quality of this operation is a dominant factor for the bit error rate (BER) performance of the system. In order to overcome the drawbacks of the conventional methods, feed forward and feedback controls are combined in the receiver architecture.

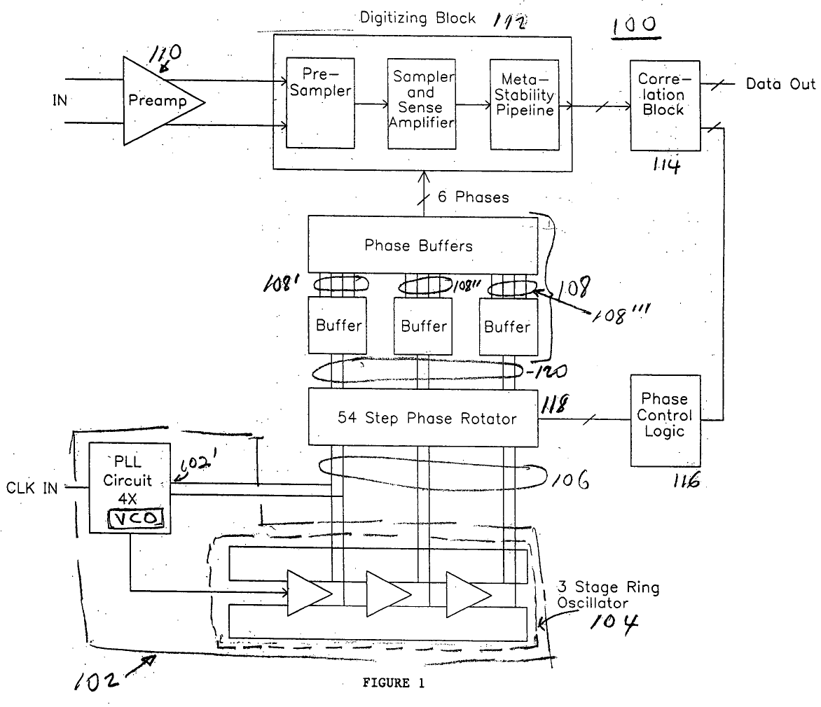

FIG. 1 shows a block diagram of clock and data recovery (CDR) system 100 according to teachings of the present invention. The CDR system 100 includes signal generation system 102 which includes phase lock loop 102′ including VCO and a three-stage ring oscillator 104. The signal generating system 102 generates multi-phase clock signals which are fed on each of the channels 106 to phase rotator 118. It should be noted that even though three input channels are shown in FIG. 1 they should not be construed as a limitation on the scope of the present invention since the number of channels selected are dictated by the designer's choice and not a limitation of the present invention. The phase rotator 118 is a system that accepts several input phases from signal generating system 102 and performs a simultaneous shift of all phases by a fixed number of degrees. In one adjustment step, only a given predetermined phase step may be accomplished. The overall phase shift is unlimited (modular 360 degrees) to allow “round-robin” operation. A more detailed description of the circuits and method used in the phase rotator 118 are set forth below and will not be discussed further at this point. Suffice it to say that the phase rotator shifts the phase of signals provided by the input channel 106 a controlled amount and outputs the shifted pulses on output channels 120 to a pool of buffers labeled 108. As with the input channels the output channels 120 are a matter of design and may be more or even less than the numbers shown in the figure. Output signals from each of the channel 120 are buffered, as shown, by buffers and each buffer outputs a pair of two phase signals on a pair of associated channels 108′, 108″ and 108′″. The two phase signals are fed into phase buffers and all six phases are fed into digitizing block 112. As will be explained subsequently the digitizing block 112 uses the signal presented at its input to oversample serial data inputted to preamplify 110. The output from preamplifier 110 is fed into the digitizing block 112. The preamplifier 110 is a fully differential amplifier which has gained both in the low frequency and flat band and has frequency boost of a certain number of db and over a certain frequency range. The values of this gain and frequency boost are largely determined by the specific application, frequency response of the transmission channel, and by anticipated signal transmit launch levels.

Still referring to FIG. 1, the function of digitizing block 112 is to oversample the signal outputted from preamplifier 110 with signal inputted by the step phase rotator and output sampled signal to correlation block 114. The correlation block in turn processes the sampled data outputs data signal or the line labeled data out and feedback control information to phase control logic 116. The phase control logic 116 generates control signal which is fed into phase rotator 118. The output from phase control logic 116 is used by the phase rotator 118 to determine the weight of the current that is applied to generate the phase shift. The digitizing block 112 contains pre-sampler (sample and hold plus buffer), sampler sense-amplifier, and metastability pipeline. In particular, this digitizing block includes one presampler (sample and hold buffer) and one sampler (sense amplifier) per bit and data edge (a total of ten samplers) and is followed by the metastability pipeline. The preamplifier sampler is implemented as a pseudo-differential sample-and hold circuit. This allows a wide range of skew correction by digital adjustment of the sampling clocks instead of using analog delay of the data. After the sample-and hold function an FF-type sampler converts the pre-sample signal to a logic level. To avoid any problems with metastable FF output a metastability pipeline is added. Even though metastabililty is believed to be well known in the art a short description of this phenomenon follows.

Metastability is defined as the operation of a digital storage element becoming stuck in the active region. During state transitions all digital elements operate for some time in the linear region. The general goal is to keep this time to a minimum. The time required for the output response to converge to a stable high or low state is referred to as settling time. When this settling time becomes excessive to the point of being a problem, we have metastability. The most obvious effect of metastability is that an unknown state is clocked into the following stage. With CMOS registers, metastability can manifest itself in two ways: 1) portions of the circuit may remain in the linear region somewhere between the voltage level of the logic 1 and a logic 0 and, 2) the circuit may actually go into oscillation. If a single stage latch does not provide adequate enough error rate numbers, the simple solutions is to use more stages. This is known as a metastability pipeline. As the number of stages increases, the number of metastability errors decreases exponentially. As stages are added the window where a metastable condition can be passed along is effectively shortened.

The correlation block 114 receives logic signals from the digitizing block 112. In the one embodiment of this invention the digitized block 112 delivers ten logic signals to the correlation block which examines the samples and ensures that certain expected sample patterns are not violated. Each sample stands either for the bit value or gives early/late information about the edge timing of the regenerated data stream. The data is outputted on the bus labeled Data Out for further processing which could include devices such as 8b/10b decoding, word aligning and so forth.

The correlation block 114 is used for the pattern recognition algorithm. Using the 6 samples coming into the receiver link logic, along with a memory from the previous 4 samples, a 10 bit register holds 2 bits of serial data (6 samples ideally in the middle of the 10 samples) and two new bits look at where the edges appear (edge information). 7 of the 10 samples are processed to pull out the edge information and generate early and late signals, which are used to eventually move the rotator and change the positioning of the edges.

The correlation block 114 specifies the early and late signals as a function of the input sample patterns. The inputs to the phase control logic 116 are the early and late signals.

The early/late signals from correlation block 114 are analyzed by phase control logic 116 and the required control signals are generated to adjust the phase rotator. This phase control logic acts like a digital filter which takes into account both the number of early and late events, the number of consecutively early and late events, the number of early and late events in a given time span, and whether or not there is an asymmetry in the number of early or the events in a predetermined time period. The latter is used to indicate whether there is a fixed offset in the frequency between the transmitter's clock and the clocks within the receiver containing the phase rotator.

The receiver structure (FIG. 1) performs clock and data recovery (CDR) on the incoming serial data stream. The quality of this operation is a dominant factor for the bit error rate (BER) performance of the system. In order to overcome the drawbacks of the conventional method, feed forward and feedback controls are combined in one receiver architecture. The data is oversampled with pulses from the phase rotator and a digital circuit detects the head portion in the data stream. This digital circuit not only selects the optimum data sample but also generates an early and late signal if the detected edges are not at its expected position. No signal is generated if no edge was found. The early and late signals are used to control the output phase position of a multi-phase phase lock loop in a feedback loop. This feedback loop takes care of low frequency jitter phenomenon of unlimited amplitude while the feed forward section surpressed high frequency jitter having limited amplitude. The static edge position is held at a constant position in the oversampled data array by a constant adjustment of the sampling phase with the early and late signals. By using the phase rotator device to control the phase output of the clock generator one PLL can be used for several receivers. This design wherein the output from a single PLL can be multiplexed to different channels is a saving of circuitry and enhanced benefit to a designer.

More particularly and according to the present invention the data is oversampled (via receiver circuits and clocked sample latches), and a digital circuit detects the edge position in the data stream. This digital circuit selects the optimum data sample, and also generates early and late signals, if the detected edge is not at its expected position. No signal is generated if no edge was found. The early and late signals are used to control the output phase positions of a multi phase PLL in a feedback loop. This feedback loop takes care of low frequency jitter phenomena (within the frequency capability of the loop to respond) of unlimited amplitude, while the feed forward section suppresses high frequency jitter having limited amplitude. The static edge position is held at a constant position in the oversampled data array by a constant adjustment of the sampling phases with the early and late signals. In principle, the early/late signals could be used to directly control the output phase positions of a multiphase clock generator PLL. This would however dictate the use of one PLL per channel. If a phase rotator device is used to control the phase output of the clock generator, one PLL may be used for several receivers.

One embodiment of the present invention provides a data sampling system in which six clocks from a single PLL are independently phase rotated. Each phase rotator inputs six PLL clocks, differentially rotates them to an arbitrary phase, and outputs six new clocks. The entire phase rotator is differential and has fixed output common mode voltage.

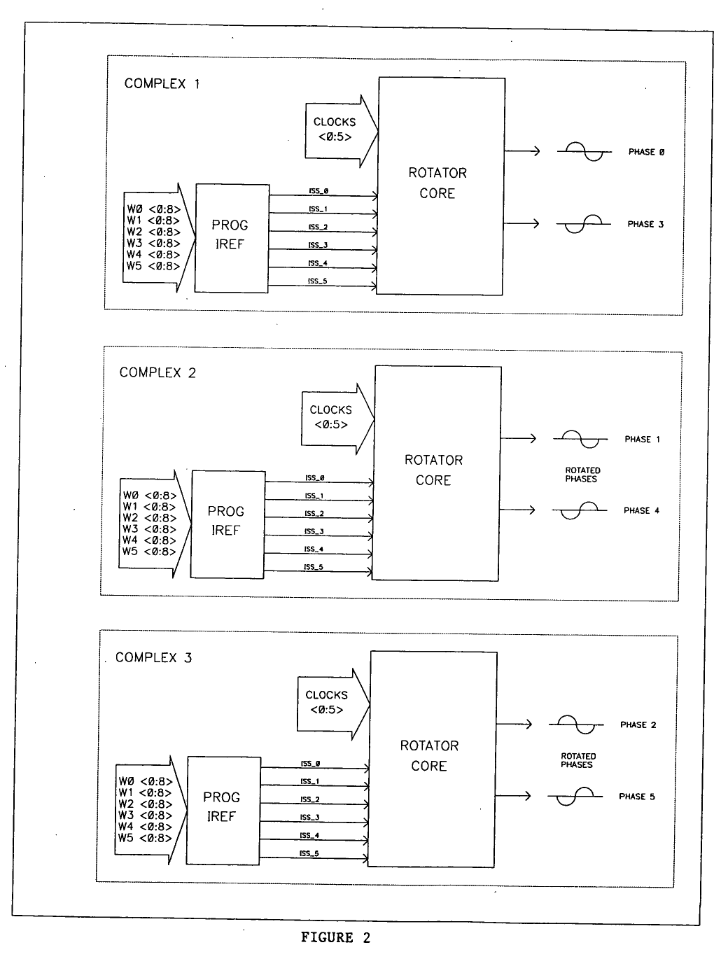

FIG. 2 illustrates the high-level circuit implementation. Six phases of an oscillating signal (CLOCKS <0:5>) are input to each of three phase rotator complexes (COMPLEX 1-3). Also input into each phase rotator complex are six programmed current values (ISS_{—}0-ISS_{—}5) which set the contributions of the six phase inputs (CLOCKS <0:5>) to the differential phase-shifted output. Each phase rotator complex outputs a differential pair of phase-shifted clocks based on the six phase inputs and six programmed current inputs.

The programmed currents are determined by nine bit programmable weighting factors, one weighting factor for each of the six programmed current outputs (PROG IREF). The tradeoff between number of weighting bits and phase rotation step size will be discussed later as well as the operation of the programmable current circuit.

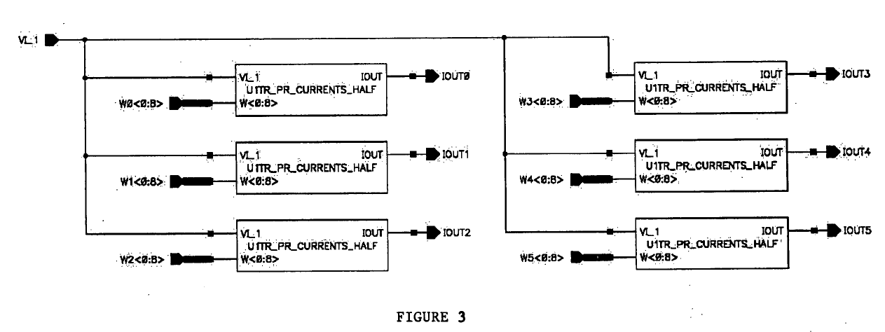

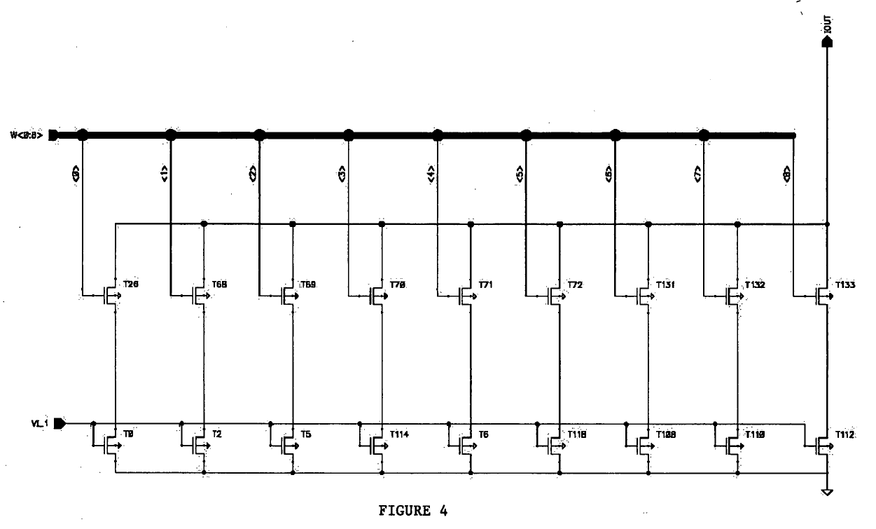

FIG. 3 illustrates the details of the PROG IREF function, specifically the programmable current generating circuit (U1TR_PR_CURRENTS_HALF). Each programmable current output (IOUT0 to IOUT5) is determined based upon a nine bit programmable weighting value. This requires a 54 bit data input to the programmable current circuit. Each nine bit weighting factor programs nine transistor currents sinks which are summed to produce one of the programmed current outputs. This embodiment is illustrated in FIG. 4. Here weighting bits 0 to 9 program transistors T26 to T133, respectively. IOUT, one of the six programmable current inputs to the phase rotator circuit, is determined by which transistors are programmed on and off. It will be clear to one skilled in the art that there are alternative ways to set the programmed current values.

In a presently preferred embodiment, the weighting coefficient supply means is arranged to cause the weighting coefficients at the input channels to evolve in a series of transition steps, an integral number m of transition steps creating a phase shift of one phase slice. The number of transition steps for creating a phase shift of one slice is preferably equal to one half the number of input channels.

In the preferred embodiment, the weighting coefficients are adapted to evolve controllably for effecting a phase shift in successive phase slices over a phase angle of 2×pi radians (360°) in a cyclic operation, thereby permitting an unlimited phase shift. In a typical operation, the distribution of weighting coefficients among the input channels at some of the intermediate transition steps at least may be unbalanced about the symmetry line of the n input channels.

Preferably, in order to minimize duty cycle distortion, each transition step involves a change in only some among the weighting coefficients applied at each of the input channels. In this case, it can be envisaged that at least one of the m transitions steps, and preferably all the intermediate transition steps, involves a change of weighting coefficient at one or more input channels on either side of the symmetry line of the n input channels.

In the preferred embodiments, the weighting coefficients are each formed by an additive combination of sub-weights. The weighting coefficient supply means can then be arranged to add or remove selectively one sub-weight per transition step to a weighting coefficient to be changed at that transition step. The sub-weights can be switched in or out of the additive combination by digital control signals generated by the weighting coefficient supply means in the form of temperature codes.

Advantageously, a weighting coefficient is expressed as a current produced by selectively adding current components each corresponding to a sub-weight forming the weighting coefficient. The current corresponding to a sub-weight may be controlled by the ON resistance of a transistor. For instance, the latter can be a MOS transistor having a specific channel width which determines the current corresponding to the associated sub-weight.

In one embodiment, at least one sub-weight is composed of an additive combination of sub-sub-weights. In this case, the weighting coefficient supply means can be arranged to add or remove selectively one sub-sub-weight per transition sub-step to a weighting coefficient to be changed at that transition step.

For each of the output channels, the weighting coefficient supply means preferably produces a same set of n weighting coefficients, the latter being applied at mutually staggered positions among the input channels of the output channels. This enables the number of different weighting coefficients to be kept small and hence more easily manageable.

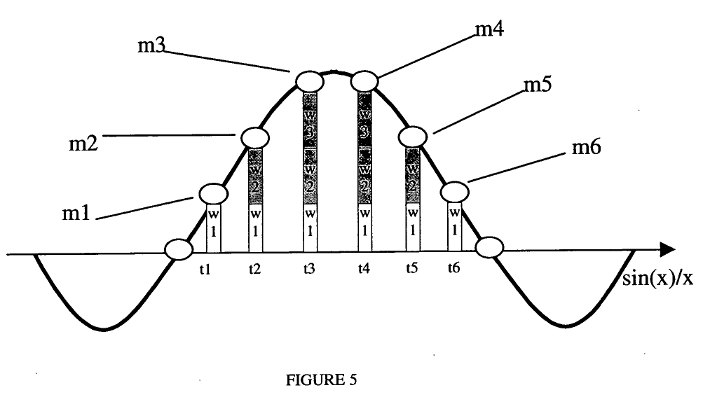

FIG. 5 illustrates a sinusoidal waveform M1-M6 constructed from a series of phases having properly weighted coefficient W1-W3. It should be noted coefficients at the center are weighed more heavily than coefficients at the ends.

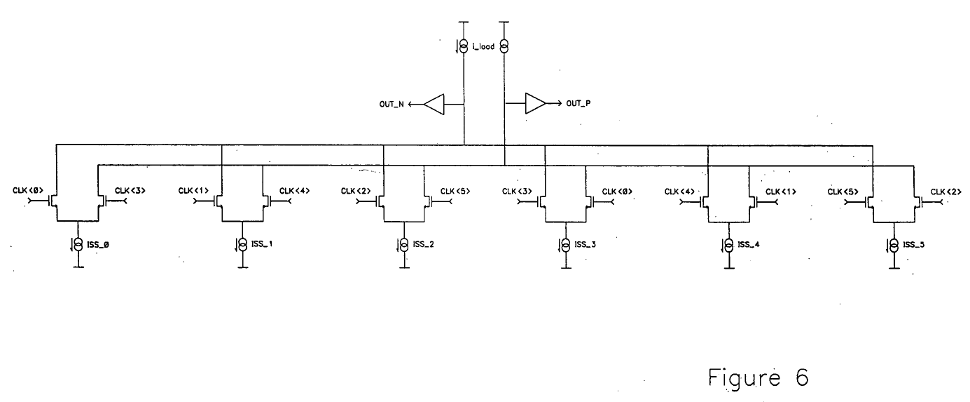

FIG. 6 illustrates the circuit structure of the phase rotator core illustrated in FIG. 2. The six programmable currents (ISS_0-ISS_5) generated by the weighting process previously described are inputs to this circuit as well as the six different phases (clocks <0:5>) from the PLL clock. The core is comprised of six differential transistor pairs, each biased by one of the programmable currents. The inputs to each differential transistor pair are two clock phases chosen from the six input clocks. Furthermore, these two phases are selected to be complementary clock pairs (180 degrees out-of-phase). The resulting differential output current of each transistor pair is in phase with these complementary input clocks, and is proportionally weighted to the programmable current which biases each transistor pair. The positive/negative outputs of each differential transistor pair are connected to the corresponding positive/negative outputs of the other five transistor pairs. The output signal yielded by the summation of all six differential transistor pairs is the vector sum of the weighted input phases, and produces the phase-shifted differential output clock phases. Thus, the output phases can be interpolated between any of the input phases by changing the weightings of each differential transistor pair bias currents (ISS_0-ISS_5).

The common-mode level of the differential output clock phases is controlled by a common-mode feedback circuit common to one skilled in the art. Such a circuit is required to control the mismatches between the differential transistor pair's output load current (ie, I_load currents) and the sum of all programming bias currents derived from PROG IREF. Such mismatches are caused by small random mismatches between transistors which form the programmable current generating circuit and rotator core.

While the invention has been particularly shown and described with references to an embodiment, it will be understood by those skilled in the art that various changes in both form and detail may be made therein without departing from the scope and spirit of the invention.

Having thus described our invention, what we claim is as follows:

1. A system comprising:
a plurality of input channels for receiving a plurality of phases of signals;
a phase rotator being responsive to at least one of the plurality of phases of the signals and operable to generate an output signal with a controlled phase shift; and
at least one output channel for delivering the output signal so generated.

2. The system of claim 1 further including a circuit arrangement, operatively coupled to the plurality of input channels, generating the plurality of signals with the plurality of phases.

3. The system of claim 2 wherein the signal oscillates.

4. The system of claim 1 or claim 2 wherein the phase rotator includes:
a programmable logic arrangement adapted for weighting a value of the signal at each of said plurality of input channels by a respective weighting coefficient;
a summer for summing the weighted signal values at each input channel and delivering the summed value as a controllably shifted output phase at the at least one output channel; and
a weighting coefficient supplier responsive to a phase shift control signal for controllably supplying evolving weighting coefficients to the programmable logic arrangement thereby to create a phase shift at the at least one output channel.

5. The system of claim 1 wherein the programmable logic arrangement includes at least one adjustable current source.

6. The system of claim 5 wherein the adjustable current source includes a Digital to Analog (DAC) converting circuit.

7. The system of claim 3 wherein the circuit arrangement includes a phase lock loop (PLL) operatively coupled to a ring oscillator wherein output from the ring oscillator being operatively coupled to the input channels.

8. The system of claim 7 wherein the ring oscillator includes n stages, n>1.

9. The system of claim 4 wherein the summer includes a plurality of differential pairs transistor connected in parallel to a common summing node.

10. The system of claim 9 further including a pair of buffer connected in parallel and operatively coupled to the summing node.

11. A method to recover clock and data signal comprising:
(a) providing a signal stream containing the clock and data;
(b) providing an oscillating signals having a plurality of phases;
(c) shifting the phase for each one of the plurality of phases of the oscillating signals with a phase rotator wherein at least one output signal with a controlled phase shift is provided;
correlating the output signal with the signal stream to detect edges and optimum sampling points in the signal stream.

12. The method of claim 11 including using edges and points so determined to recover the clock and data.

13. The method of claim 12 wherein recovering the clock and data includes receiving in a correlation circuit arrangement the edges and optimum sampling points in said signal streams;
examining said signals to insure certain expected sample patterns are not violated; and
outputting on a first bus the data and on a second bus early/late signals.

14. The method of claim 13 further including receiving the early/late signals in a phase control logic arrangement;
analyzing the early/late signals; and
generating control signals based upon said analysis to adjust said phase rotator.

15. A phase rotator for controllably effecting a phase shift on an oscillating signal comprising:
input means having a plurality of input channels for receiving a plurality of phases of the oscillating signal;
output means having at least one output channel for delivering at least one phase of the oscillating signal with a controlled phase shift;
weighting means for weighting the value of the oscillating signal at each input channel by a respective weighting coefficient;
summing means for summing the weighted signal values at each input channel and delivering the summed value as a controllably shifted output phase at the output channel; and
weighting coefficient supply means responsive to a phase shift control signal for controllably supplying evolving weighting coefficients to the weighting means thereby to create a phase shift at the output channel.
